(19) United States
(12) Patent Application Publication
(10) Pub. No.: US 2023/0383986 A1
(43) Pub. Date: Nov. 30, 2023

(54) Shutter Auxiliary Opening and Closing Device

(71) Applicant: The GSI Group (Shanghai) Co., Ltd, Shanghai (CN)

(72) Inventors: Rock Zhou, Shanghai (CN); Yu Shao, Suzhou (CN)

(21) Appl. No.: 18/322,676

(22) Filed: May 24, 2023

(30) Foreign Application Priority Data
May 31, 2022 (WO) PCT/CN2022/096248

(51) Int. Cl. F24F 13/15; F24F 7/013

(52) U.S. Cl. CPC F24F 13/15; F24F 2007/0025; F24F 7/013

(57) ABSTRACT

A ventilation shutter has a frame forming the mounting structure for a plurality of louvers that are pivotably mounted so as to move between an open condition to allow ventilation air through the shutter and a shut condition. The ventilation shutter includes at least one connecting rod extending transverse the louvers and a plurality of cranks, where each of the louvers has at least one crank connecting the louver to the connecting rod such that pivoting movement of the louvers between the shut condition and the open condition is synchronized with up and down movement of the connecting rod. A permanent magnet couple interacts with the connecting rod and the frame to provide an active magnetic force that holds the louvers in the shut condition. An electromagnet couple interacts with the connecting rod and the frame to provide an active magnetic force that holds the louvers in the open condition.

### CROSS-REFERENCE TO RELATED APPLICATIONS

This application is a continuation application of International Application No. PCT/CN2022/096248, filed May 31, 2022, and entitled SHUTTER AUXILIARY OPENING AND CLOSING DEVICE, the contents of which are hereby incorporated by reference in their entirety.

### BACKGROUND OF THE INVENTION

### Field of Invention

This invention relates to climate control systems for buildings used to house animals, and more particularly to a ventilation shutter used to control the passage of air between the interior and the outside of the building.

### Description of Related Art

Maintaining a proper climate in buildings where living creatures such as poultry, swine or livestock are maintained is highly desirable. A well-controlled environment involves monitoring and regulating the temperature, relative humidity and air quality in the building. For example, properly controlled temperatures enable animals to use feed for growth rather than for body heat. A properly heated animal house results in lower feed costs and increased animal productivity. Additionally, control over the level of humidity in the building is necessary because excess humidity contributes to animal discomfort and promotes the growth of harmful air born bacteria that can cause respiration diseases. Having an elevated humidity level in the animal house may also lead to more frequent changes of bedding and litter which increases production costs. An important component in maintaining a proper environment in such buildings is providing proper ventilation.

There are many designs of air ventilating systems that can be used to control ventilation. These systems typically contain ventilating fans in cooperation with shutters over air openings used to bring in fresh air into and exhaust stale air from the interior of the building. The shutters typically have pivoted louvers moveable between an open position and a closed position. When ambient temperatures are high, movement of air into the interior of the building is essential to maintain proper conditions inside the building. However, when ambient temperatures are low, introduction of cold outside air increases heating costs. Most traditional shutters allow outside air to leak into the building. Leakage of unwanted outside air into the building during cold temperatures increases heating costs, since more fuel is required to maintain the desired temperature. Desirably, the louvers operate automatically in response to the negative or positive pressure created in the building by the ventilation fans. However, with known ventilation shutters of the automatic type, the louvers often do not seal completely, thus allowing outside air to leak through the shutter even when the shutter is closed. Additionally, the structure of the shutter provides continuous suction when the louvers are opened, which helps the blades to overcome gravity and remain in the open position. However, even when the ventilation fans are running, the louvers can sag due to gravity, which increases wind resistance and slows down the air flow rate.

There is therefore a need for an improved shutter system having multiple louvers which when mounted in the wall of the building will provide an airtight system, resulting in minimal air leakage with minimal heat loss or cold air entering the building when the shutter is closed and which ensures the louvers are open fully when desired to decrease resistance to the desired ventilation flow.

### BRIEF SUMMARY

In one aspect, the invention is directed to a ventilation shutter having a frame forming the mounting structure for a plurality of louvers, where the plurality of louvers are pivotably mounted to the frame so as to move between an open condition to allow the flow of ventilation air through the shutter and a shut condition to discourage a flow of air through the shutter. The ventilation shutter includes at least one connecting rod extending transverse the plurality of louvers and a plurality of cranks, where each of the plurality of louvers has at least one crank connecting the louver to the at least one connecting rod such that pivoting movement of each of the plurality of louvers between the shut condition and the open condition is synchronized with up and down movement of the at least one connecting rod. A permanent magnet couple interacts with the at least one connecting rod and the frame to provide an active magnetic force that holds the plurality of louvers in the shut condition. An electromagnet couple interacts with the at least one connecting rod and the frame to provide an active magnetic force that holds the plurality of louvers in the open condition.

These and other features and advantages of this invention are described in, or are apparent from, the following detailed description of various exemplary embodiments of the systems and methods according to this invention.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a ventilation shutter according to an embodiment of the invention, showing a plurality of louvers in the shut position;

FIG. 2 illustrates perspective view of the ventilation shutter of FIG. 1 showing the plurality of louvers in the open position.

FIG. 3A illustrates an enlarged portion of the shutter of FIG. 1 with the louvers in the shut position.

FIG. 3B illustrates an enlarged portion of the shutter of FIG. 1 with the louvers in the open position.

FIG. 4A illustrates an enlarged portion of the shutter of FIG. 1 with the louvers in the shut position.

FIG. 4B illustrates an enlarged portion of the shutter of FIG. 1 with the louvers in the open position.

Corresponding reference characters indicate corresponding parts throughout the views of the drawings.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

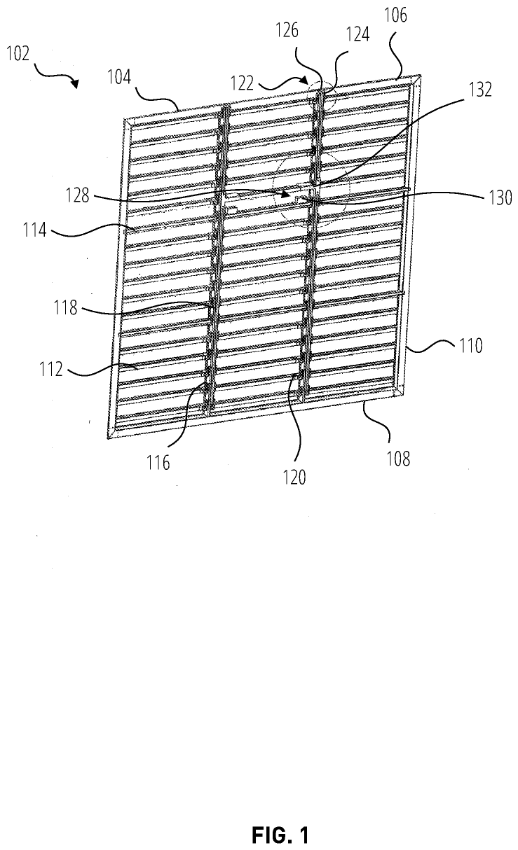

Referring to FIG. 1, a ventilation shutter 102 has a rectangular frame 104 configured such that the ventilation shutter 102 of the invention can be installed in an opening in a wall of a building (not shown) to be ventilated. As is well known to those skilled in the art, the ventilation shutter 102 is combined with one or more fans (not shown) which, when on, will cause outside air to be drawn into the building to provide ventilation of the building. The frame 104 includes a top member 106, a bottom member 108 and two side members 110 that comprise the mounting structure for a plurality of louvers 112. As one skilled in the art will understand, the frame 104 may have one or more horizontal internal cross member 114 and/or vertical internal cross member 116 to provide rigidity to the frame 104. The illustrated embodiment shows both horizontal internal cross members 114 and vertical internal cross members 116, however one skilled in the art will understand that the frame 104 may only have one or the other internal cross member, or no internal cross member without departing from the scope of the invention. The number of horizontal internal cross members 114 and vertical internal cross members 116 depends upon the size of the ventilation shutter 102 and its specific structural requirements using sound engineering judgment.

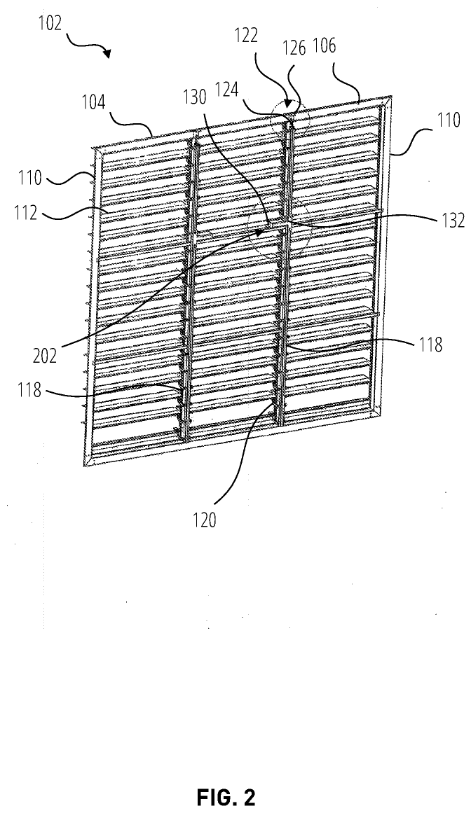

In the illustrated embodiment, the louvers 112 are oriented with a horizontal axis with opposing ends of each louver 112 pivotally mounted to either a side member 110 or a vertical internal cross member 116 of the frame 104 so that louvers 112 of the ventilation shutter 102 are pivotable between an open condition as shown in FIG. 1 to allow the flow of ventilation air through the shutter or in a shut condition as shown in FIG. 2 to prevent unwanted leakage of outside air into the building. At least one connecting rod 118 extends transverse the plurality of louvers 112 generally between the top member 106 and the bottom member 108. Each louver 112 is connected to at least one of the connecting rods 118 with a crank 120 such that pivoting movement of the louver 112 between the shut condition and the open condition is synchronized with up and down movement of its associated connecting rod 118. In the illustrated embodiment, the connecting rods 118 are positioned adjacent vertical internal cross members 116 so that they are at an end of a column of louvers 112. However, the connecting rods 118 may also be positioned such that the connecting rod 118 is located somewhere intermediate opposing ends of the louvers 112.

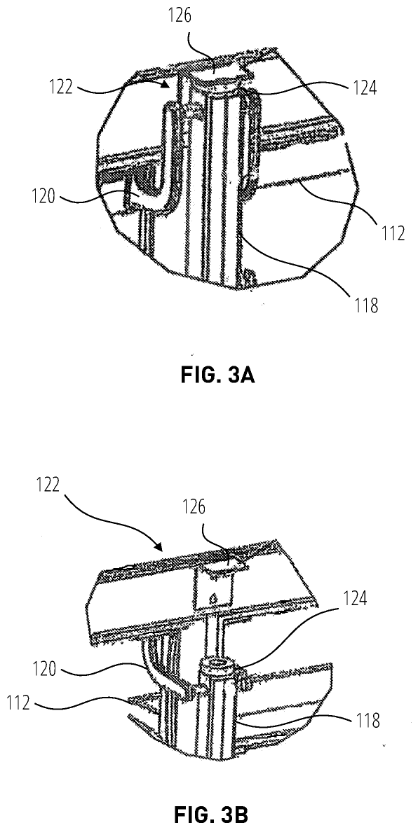

The ventilation shutter 102 has a permanent magnet couple 122 that provides an active magnetic force that holds the louvers 112 in the shut condition. On one embodiment, as perhaps best seen in the enlarged views of FIG. 3A and FIG. 3B, the permanent magnet couple 122 includes a moveable permanent magnet 124 that is mounted on the connecting rod 118 so that the moveable permanent magnet 124 moves relative the frame 104 with up and down movement of the connecting rod 118. In the illustrated embodiment, the moveable permanent magnet 124 is mounted on an upper end of the connecting rod 118. However, one skilled in the art will understand that the moveable permanent magnet 124 may alternately be mounted on a lower end of the connecting rod 118 or at a position intermediate its upper and lower ends without departing from the scope of the invention using sound engineering judgment. The permanent magnet couple 122 also includes a permanent magnet limit block 126 that is attached to the frame 104 and configured to interact with the moveable permanent magnet 124. In the illustrated embodiment, the permanent magnet limit block 126 is mounted to the top member 106 of the frame 104.

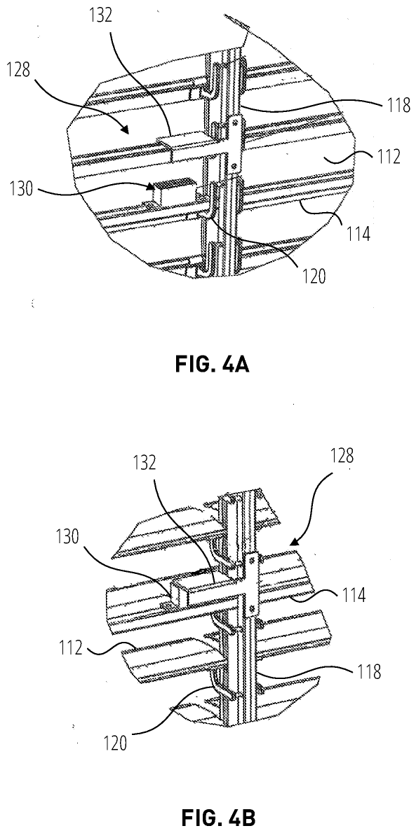

The ventilation shutter 102 also has an electromagnet couple 128 that provides an active magnetic force that holds the louvers 112 in the open condition. As perhaps best seen in the enlarged views of FIG. 4A and FIG. 4B, in one embodiment the electromagnet couple 128 includes an electromagnet limit block 130 that is attached to the frame 104 of the ventilation shutter 102 and an electromagnet sheet 132 that is attached to the connecting rod 118 and configured to interact with the electromagnet limit block 130. In the illustrated embodiment, the electromagnet limit block 130 is attached to the horizontal internal cross member 114. However, one skilled in the art will understand that the electromagnet limit block 130 may be mounted on the connecting rod 118 and the electromagnet sheet 132 may be mounted on the frame 104 using sound engineering judgment without departing from the scope of the invention.

When the louvers 112 are in the closed condition, the cranks 120 position the connecting rod 118 as shown in FIG. 3A such that the moveable permanent magnet 124 and the permanent magnet limit block 126 are in close proximity and are magnetically attracted to each other. This magnetic force is transmitted to each louver 112 through the connecting rod 118 so that the louvers 112 are held in the shut condition by the magnetic force between moveable permanent magnet 124 and permanent magnet limit block 126. Actively holding the louvers 112 in the shut condition decreases unwanted leakage of air through the ventilation shutter 102.

In operation, when an airflow blows through the ventilation shutter 102, the louvers 112 pivot from the shut condition as shown in FIG. 2 toward the open condition as shown in FIG. 1. As each louver 112 opens, the crank 120 connected to the louver 112 causes the connecting rod 118 to move. In the illustrated embodiment, this movement is in a downward direction. Downward movement of the connecting rod 118 also causes the moveable permanent magnet 124 and the electromagnet sheet 132 that are mounted on the connecting rod 118 to also move along with the connecting rod 118. The movement of the connecting rod 118 forcibly separates the moveable permanent magnet 124 from the permanent magnet limit block 126 as shown in FIG. 3B. As the louvers 112 approach the fully open condition, the moveable permanent magnet 124 is desirably a sufficient distance away from the permanent magnet limit block 126 such that the permanent magnet couple 122 no longer exerts a magnetic force sufficient to pull the louvers 112 back toward the closed condition.

The electromagnet couple 128 is also energized when the external fan is set to run. In the illustrated embodiment, movement of the connecting rod 118 also causes the electromagnet sheet 132 to move downward toward the electromagnet limit block 130. As the distance between the electromagnet sheet 132 and electromagnet limit block 130 decreases, the magnetic force between the electromagnet limit block 130 and the electromagnet sheet 132 pulls electromagnet sheet 132 to the electromagnet limit block 130 until they are completely attracted together. Thus as air flow rate reaches the maximum, the electromagnet couple 128 holds the louvers 112 in the fully open condition to reduce wind resistance, thus increasing the efficiency to the ventilation shutter 102.

When it is desired to close the ventilation shutter 102, the ventilation fan is turned off and the electrical current to the electromagnet couple 128 is cut off. The louvers 112 will fall freely due to gravity thereby causing the connecting rod 118 to move upwards, and the moveable permanent magnet 124 will once again move into close proximity with the permanent magnet limit block 126 such that the permanent magnet couple 122 provides a force to hold the louvers 112 in the shut condition.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A ventilation shutter having a frame forming the mounting structure for a plurality of louvers, wherein the plurality of louvers are pivotably mounted to the frame so as to move between an open condition to allow the flow of ventilation air through the shutter and a shut condition to discourage a flow of air through the shutter, the ventilation shutter comprising:
at least one connecting rod extending transverse the plurality of louvers;
a plurality of cranks, wherein each of the plurality of louvers has at least one crank connecting the louver to the at least one connecting rod such that pivoting movement of each of the plurality of louvers between the shut condition and the open condition is synchronized with up and down movement of the at least one connecting rod;
a permanent magnet couple interacting with the at least one connecting rod and the frame to provide an active magnetic force that holds the plurality of louvers in the shut condition; and
an electromagnet couple interacting with the at least one connecting rod and the frame to provide an active magnetic force that holds the plurality of louvers in the open condition.

2. The ventilation of claim 1 wherein the permanent magnet couple comprises a moveable permanent magnet that is mounted on the connecting rod so that the moveable permanent magnet moves relative the frame with up and down movement of the connecting rod, and the permanent magnet couple also comprises a permanent magnet limit block that is attached to the frame and configured to interact with the moveable permanent magnet.

3. The ventilation of claim 2 wherein the moveable permanent magnet is mounted on an upper end of the connecting rod and the permanent magnet limit block is mounted to a top member of the frame.

4. The ventilation shutter of claim 3 wherein the electromagnet couple includes an electromagnet limit block that is attached to the frame and an electromagnet sheet that is attached to the connecting rod and configured to interact with the electromagnet limit block.

5. The ventilation shutter of claim 4 wherein the electromagnet limit block is attached to a horizontal internal cross member of the frame.

6. The ventilation shutter of claim 4 wherein when the plurality of louvers are in the closed condition, the cranks position the connecting rod such that the moveable permanent magnet is in close proximity to magnetically attracted to the permanent magnet limit block and a magnetic force is transmitted to each louver through the connecting rod so that the louvers are held in the shut condition by the magnetic force.

7. The ventilation shutter of claim 6 wherein when an airflow blows through the ventilation shutter, the plurality of louvers pivot from the shut condition toward the open condition causing the crank connected to each of the plurality of louvers to cause the connecting rod to move, which movement of the connecting rod also causes the moveable permanent magnet and the electromagnet sheet that are mounted on the connecting rod to also move.

8. The ventilation shutter of claim 7 wherein the movement of the connecting rod is in a downward direction.

9. The ventilation shutter of claim 7 wherein the movement of the connecting rod forcibly separates the moveable permanent magnet from the permanent magnet limit block such that the plurality of louvers approach the open condition, the moveable permanent magnet is of a sufficient distance away from the permanent magnet limit block such that the permanent magnet couple no longer exerts a magnetic force sufficient to pull the louvers back toward the closed condition.

10. The ventilation shutter of claim 7 wherein movement of the connecting rod causes the electromagnet sheet to move toward the electromagnet limit block.

11. The ventilation shutter of claim 10 the magnetic force between the electromagnet limit block and the electromagnet sheet pulls electromagnet sheet to the electromagnet limit block.

12. The ventilation shutter of claim 10 wherein when it is desired to close the ventilation shutter, the airflow through the ventilation shutter is stopped and the electrical current to the electromagnet couple is cut off, thereby causing the plurality of louvers to fall due to gravity toward the shut condition thereby causing the connecting rod to move such that the moveable permanent magnet moves into close proximity with the permanent magnet limit block such that the permanent magnet couple provides a force to hold the louvers in the shut condition.

13. The ventilation shutter of claim 1, wherein the frame comprises at least one internal cross member and the at least one connecting rod is positioned adjacent the internal cross member.

14. The ventilation shutter of claim 1, wherein the electromagnet couple is also energized when an airflow is directed through the ventilation shutter.
